(19) United States
(12) Patent Application Publication
(10) Pub. No.: US 2017/0303699 A1
(43) Pub. Date: Oct. 26, 2017

(54) COVER ASSEMBLY

(71) Applicant: Molly Sullivan Howe, Westport, CT (US)

(72) Inventor: Molly Sullivan Howe, Westport, CT (US)

(21) Appl. No.: 15/476,135

(22) Filed: Mar. 31, 2017

Related U.S. Application Data
(60) Provisional application No. 62/340,824, filed on May 24, 2016.
(60) Provisional application No. 62/327,128, filed on Apr. 25, 2016.

(51) Int. Cl. A47C 31/11; A47J 37/07; B60J 11/04; B62J 19/00

(52) U.S. Cl. CPC A47C 31/11; B62J 19/00; A47J 37/0786; B60J 11/04

(57) ABSTRACT

Provided is a cover and a cover assembly for use in covering objects such as an outdoor furnishing, equipment, utilities and the like. The cover includes a compartment that removably attaches to the object and a cover portion that is stored in the compartment. The compartment includes a pouch-shaped interior and a pouch-extending tongue that is connected to the pouch-shaped interior and that attaches to a cover-extending tongue that is connected to an underneath side of the cover portion thereby attaching the cover portion to the compartment. In various embodiments, a space exists on the underneath side of the cover portion between the cover-extending tongue and an exterior edge of the cover portion such that when the cover portion is on the object, the exterior edge hangs below the compartment thereby covering the compartment while the cover portion remains attached to the compartment via the cover-extending tongue.

### CROSS REFERENCE TO RELATED APPLICATION

The present application claims the benefit under 35 USC §119(e) of U.S. Provisional Patent Application No. 62/327,128, filed on Apr. 25, 2016, and U.S. Provisional Patent Application No. 62/340,824, filed on May 24, 2016, the entire contents of both of which are hereby incorporated by reference for all purposes.

### BACKGROUND

In just a short amount of time, outdoor objects such as furniture, cushions, grills, fire pits, entertainment centers, Jacuzzis, indoor/outdoor equipment, air compressors, machinery, bikes, cars, boats, boating seats, and the like, may start to show age with rust marks, mildew, stains, and other forms of deterioration. In order to prevent aging, some objects are manufactured using materials that have been made with a protective coating which helps to repel/resist water, moisture, mold and mildew. However, the protective coating can wear down over time as the object is used and cleaned. To maintain the original beauty and condition of the investment, and to protect it from dirt, dust, water, pollen, wind, and other elements when not in use, temporary coverings such as tarps are often used.

However, many covers require a user to spend a significant amount of time tying the cover down, buttoning pieces together, strapping pieces in, etc. Furthermore, when the user needs to use the outdoor object, the cover or tarp typically cannot be conveniently stored or stored at a position on the object without interrupting the use of the object and therefore must be removed and stored elsewhere; be it a shed, barrel, basement, garage, etc. Accordingly, what is needed is a means for providing adequate covering protection to outdoor (and indeed indoor) objects and the ability to store that protection in convenient, easy to use storage while offering a deployment system that is connected on the object while also being easily and efficiently stored when not in use.

### SUMMARY

In an aspect of an example embodiment, provided is a cover assembly that includes a compartment that removably attaches to an object and includes a pouch-shaped interior and a rollable pouch-extending tongue that includes an interior end that is connected to the pouch-shaped interior and a distal end that is opposite to the attached end, wherein, when rolled-up, the pouch-extending tongue fits inside the pouch-shaped interior, and when unrolled, the distal end of the pouch-extending tongue extends outward and away from the pouch-shaped interior, and a cover portion that has a shape and size configured to cover the object, the cover portion comprising a cover-extending tongue that is connected to an underneath side of the cover portion and a distal end that extends outward and is configured to attach to the distal end of the pouch-extending tongue thereby attaching the cover portion to the compartment. A predetermined space exists on the underneath side of the cover portion between the cover-extending tongue and an exterior edge of the cover portion such that when the cover portion covers the object, the exterior edge hangs below the compartment thereby covering the compartment while the cover portion remains attached to the compartment via the cover-extending tongue.

In an aspect of another example embodiment, provided is a cover that includes a compartment that removably attaches to the object and includes a pouch-shaped interior, and a rollable cover portion that has a shape and size configured to cover the object, the rollable cover portion comprising a tongue that is connected to an underneath side of the rollable cover portion and, at an opposite end thereof, is integrated within the pouch-shaped interior of the compartment thereby connecting the cover portion and the compartment. In this example, when rolled-up, the rollable cover portion fits inside the pouch-shaped interior of the compartment, and when unrolled, the rollable cover portion unrolls outward and away from the pouch-shaped interior and is capable of being placed over the object, and a predetermined space exists on the underneath side of the rollable cover portion between the tongue and an exterior edge of the rollable cover portion such that when the rollable cover portion covers the object, the exterior edge drops below the compartment thereby covering the compartment while the rollable cover portion remains attached to the compartment via the tongue.

Other features and aspects may be apparent from the following detailed description in conjunction with the claims and the drawings.

### BRIEF DESCRIPTION OF THE DRAWINGS

Features and advantages of the exemplary embodiments, and the manner in which the same are accomplished, will become more readily apparent with reference to the following detailed description taken in conjunction with the accompanying drawings.

FIGS. 1-5 are diagrams illustrating an exterior of a cover assembly in accordance with various example embodiments.

FIGS. 6A-6C are diagrams illustrating a cover portion of the cover assembly after it is removed from a compartment of the cover assembly, in accordance with various example embodiments.

FIGS. 7A-7B are diagrams illustrating the cover portion while covering an object in accordance with the example embodiments.

FIGS. 8A-8B are diagrams illustrating examples of rolling the cover portion of the cover assembly in accordance with example embodiments.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various exemplary embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The examples herein are directed to a cover (also referred to herein as a cover assembly) that may be used to protect objects. For example, the cover may be waterproof, heat-resistant, and the like, and may be able to withstand year-round weather and elements, as well as protect from pollen, dust, etc. in an indoor environment. The cover can be used to protect many different types of objects such as furniture (e.g., indoor furniture, outdoor furniture, tables, chairs, sofas, etc.), boat seats, yacht furniture, equipment, machinery, vehicles (e.g., work vehicles, leisure vehicles, motorcycles, motorbikes, bicycles, tractors, cars, campers, ATVs etc.) garden equipment, patio furniture, plants, and the like. The cover may be used to protect objects that are in an outdoor setting and which may be vulnerable to rains, snow, ice, and high temperatures and all other outdoor elements. Also, the cover may be used for covering objects in indoor settings where dust, pollen, and other particles can fill the air. The objects capable of being covered by the cover assembly should not be construed as being limited to the examples provided herein.

The cover includes a cover portion (also referred to as a cover piece) for covering the object and a compartment for storing the cover portion when it is not in use. The cover portion and the compartment may be integrated together as a uniform piece, or in the alternative, the cover portion and the compartment may be attachable/detachable from one another in a cover assembly thereby enabling a user to assemble the cover portion to the compartment and also substitute a different cover portion should the need arise to cover a different size/shape object. When not in use, the cover portion may be rolled up and/or folded and stored within the compartment by the user.

The compartment is capable of being easily and conveniently carried by a user while the cover portion is rolled-up/folded and stored therein. For example, the compartment may have a strap capable of being worn around the shoulder of a user, but is not limited thereto. The compartment does not need to be attached to an object but may be used as a storage system for storing the cover portion. According to various aspects, the compartment may include a duffle bag shape (e.g., cylinder, sphere, cube, rectangle, etc.) that includes an adjustable attachment mechanism such as a strap, Velcro, ties, buckles, elastic, magnets, hooks and loops, etc., and is capable of attaching to on object temporarily. The compartment may include the aforementioned strap such as an adjustable strap connected on an exterior of the compartment and which can be held in a user's hand or carried around a user's shoulder. In some cases, the strap can be detachable from the compartment such that the strap can be separated from the compartment.

During deployment of the cover portion, the cover portion may be withdrawn from the compartment by a user and placed over the object such that the cover portion provides coverage for both the object and the compartment while at the same time maintaining an attachment to the compartment. Accordingly, the cover assembly can be removably attached to the object, and the cover portion may be quickly and easily deployed into a covering position for both the object and the compartment housing the cover portion. Furthermore, the cover portion can be quickly put away (e.g., rolled-up and inserted into the compartment) when use is no longer desired and stored on the object without interrupting the use of the object. In some examples, the compartment may also include a mesh ventilation panel or panels that provide ventilation to the cover portion while it is folded, rolled-up, or otherwise compressed inside the compartment.

The cover assembly may be waterproof and/or heat resistant. The compartment and the cover portion may be made of a flexible material that may be inherently waterproof and/or heat resistance, or applied with other chemicals and/or materials to be waterproof and/or heat resistance. For example, the material used to construct the compartment and the cover piece may be a fabric including one or more of vinyl, nylon, polyester, cotton, Gore-Tex, rubber, silicone, and the like. However, a type of material is not limited to these examples. Because the cover portion may be flexible (e.g., fabric or cloth material), a user may be able to place the cover piece over the object and gravity can cause the cover portion to fall down and hang around the object with ease.

The cover assembly described herein has a number of advantages in comparison to related covers and other traditional means for protecting objects. For example, the compartment of the cover assembly may include an adjustable strap which may also include a buckle or other separating mechanism for securing the compartment to different types of objects. The cover assembly also includes a unique interior attachment/detachment system that includes one or more tongues disposed between the compartment and the cover portion that allow the cover portion to be deployed and placed around the object while maintaining adequate covering for both the object and the compartment, while the cover portion is able to maintain a connection to the compartment. The compartment may remain attached to the object at a same position while the cover portion is both in use and not in use creating an easy and efficient use of the cover assembly. Furthermore, the compartment may be attached to different locations on the object and the cover portion may be able to adequately cover the object. That is, even though the compartment may be attached at different locations on the object, the cover portion may still provide adequate cover and protection to the object at each of these positions based on a size of the cover portion and/or the interior unique tongue system connecting the cover portion and the compartment.

The cover portion can include an attachment mechanism such as a zipper, buttons, ties, etc., that attaches and detaches the cover portion to and from the compartment. In the alternative, the cover portion may be uniformly integrated together with the compartment without requiring attachment. The cover portion and the one or more tongues may be compressed in some fashion, for example, by rolling, folding, bending, and/or the like, by the user, and stored within the compartment. Furthermore, because the cover portion remains attached to the compartment while in the covering state, the cover portion may be easily returned to the compartment when the user desires to uncover the object.

Another benefit of the cover assembly described herein is the ability of the compartment to be easily attached to an object by a simple user action (e.g., sliding the strap around the object, buckling the strap around the object, placing the strap over the object, etc.) which secures the cover portion to the object via the compartment. Here, the compartment and the cover portion may remain in place and attached to the object and not be blown away when exposed to wind or other elements. Another benefit of the cover is that the object does not need to be specially designed or specially modified (e.g., with specific attachment mechanisms) for the cover, or vice versa. The cover may be flexible and may be used on different sized objects and at different locations on an object because of the unique interior tongue attachment system.

FIGS. 1-5 illustrate various examples of an exterior view of a cover assembly 100 in accordance with the embodiments. Referring to the example of FIG. 1, the cover assembly 100 includes a strap 102 that can be worn as a shoulder strap, held as a hand-held strap, and the like, and carried by a user 10. Although not shown in FIGS. 1-5, the cover assembly 100 includes a cover piece stored within an interior body (also referred to herein as a compartment) of the cover assembly 100. The cover assembly 100 is easily portable. Also, it should be appreciated that a size of the cover assembly 100 (and the cover piece) is not limited to the examples shown herein, but may be bigger or smaller and have a different shape depending on a type of object that is being covered. For example, while furniture is shown in the examples herein as the object being covered by the cover assembly 100, other objects may be covered without deviating from the scope of the example embodiments. Also, rather than a strap 102, the cover assembly may include other components for attaching to the object to be covered such as magnets, ties, string, hooks and loops, and the like.

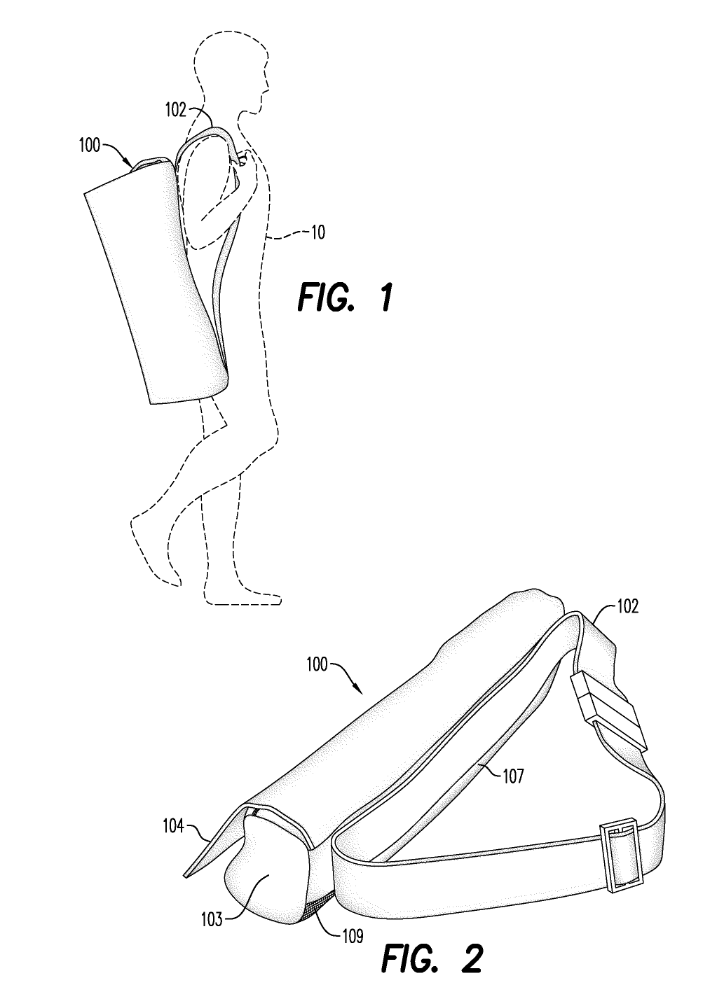

FIG. 2 further illustrates an example of the cover assembly 100. In this example, the adjustable strap 102 is attached to a back portion 107 of a compartment 103 (or body) of the cover assembly 100. The adjustable strap 102 may be adjusted by the user to reduce a length of the strap 102 and to increase a length of the strap 102. In some examples, the strap 102 may include a buckle that attaches and detaches to itself and that allows the strap to be attached at various locations on and secured to the object without having to increase/decrease the length of the strap. A buckle end may be slid into spaces and openings such as between arms of chairs. However, the compartment 103 does not require a strap to be used to attach the compartment 103 to an object, and may include another means for attaching to an object such as magnets, hooks and loops (e.g., VELCRO), strings, ties, etc. Also, the compartment 103 does not need to be attached to a specific location on the object but may be attached at numerous desired locations and heights on the object.

In addition, FIG. 2 illustrates a flap 104 that extends outwards from a top portion of the compartment 103 and over a front portion of the compartment 103. The flap 104 is used to protect and hide an opening (shown later) in the compartment 103. In the example of FIGS. 1-5, the compartment 103 has a shape of a duffle bag and is made of a flexible fabric, however, the embodiments are not limited thereto. As another example, the compartment 103 may have a spherical shape, a cubical shape, an elliptical shape, a rectangular shape, and the like. Also, the compartment 103 is not limited to a flexible fabric material but may be made of a more rigid material such as plastic, a hard rubber, silicone, and the like.

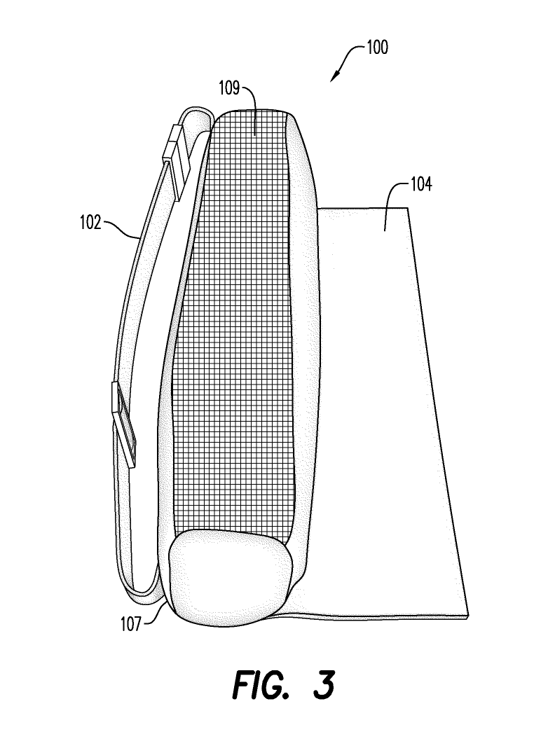

FIG. 3 illustrates a view of a bottom of the compartment 103 of the cover assembly 100. In this example, the bottom of the compartment 103 includes ventilation 109 that allows for air to enter into and exit out of the compartment 103 and circulate within the compartment 103 in order to ventilate the cover portion as well as other contents that might be stored inside. The ventilation 109 may be located in other areas of the compartment 103, for example, on the sides, on the top, and the like. The ventilation 109 may include a mesh-type material in which air is able to pass through. In the example of FIG. 3, the ventilation 109 has a size and a shape that is approximately the same as the compressed cover portion rolled up/folded inside the compartment 103.

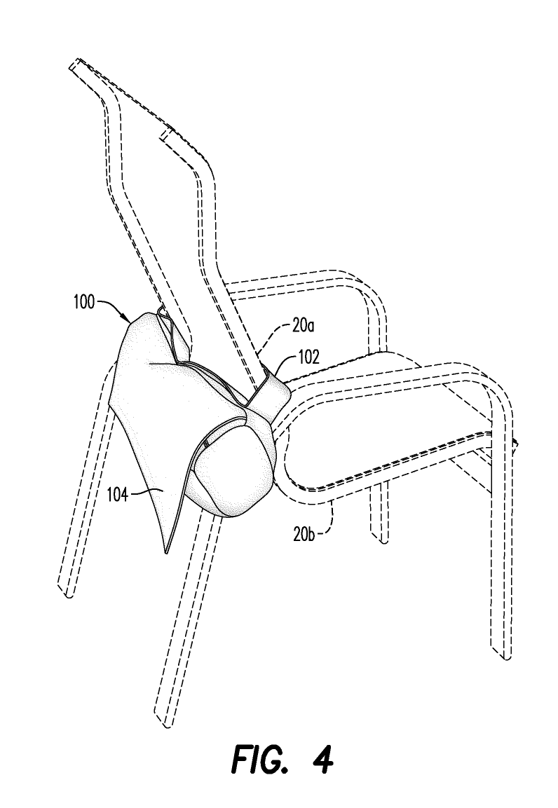

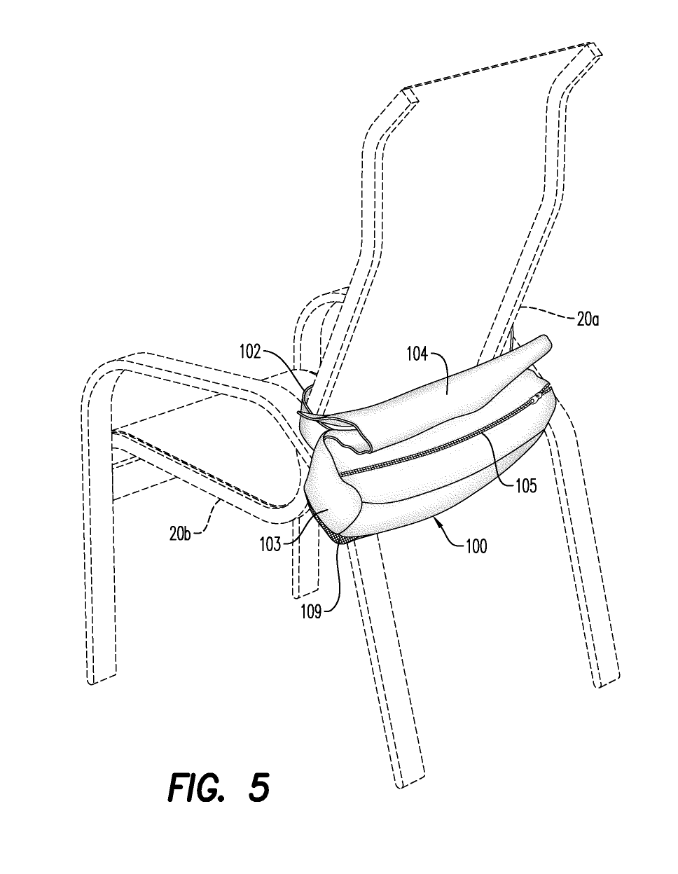

FIG. 4 illustrates an example in which the cover assembly 100 is attached to an object which in this example is a chair. The chair may be an outdoor chair such as a patio chair, a boating chair, etc., or it may be an indoor chair such as a recliner, a kitchen chair, etc. In this example, the compartment 103 is secured to a back 20a of the chair using the strap 102. Although, it should be appreciated that the compartment 103 may be secured to other portions of the chair such as the seat 20b, and the like. During operation and use, the compartment 103 may be attached at various heights that a user desires and the cover portion will be able to cover both the compartment 103 and the chair (or other type object). According to various embodiments, a front of the compartment 103 may face away from the back 20a of the chair. Also, as shown in the combination of FIGS. 4 and 5, the flap 104 may protect and hide an opening 105 into the compartment 103. The opening 105 provides a user access to the portion cover stored therein. In this example, the opening 105 includes an opening/closing mechanism such as a zipper enabling the user to open and close the opening 105. As another example, the opening/closing mechanism may be buttons, ties, or the compartment may not include a closing mechanism around the opening 105.

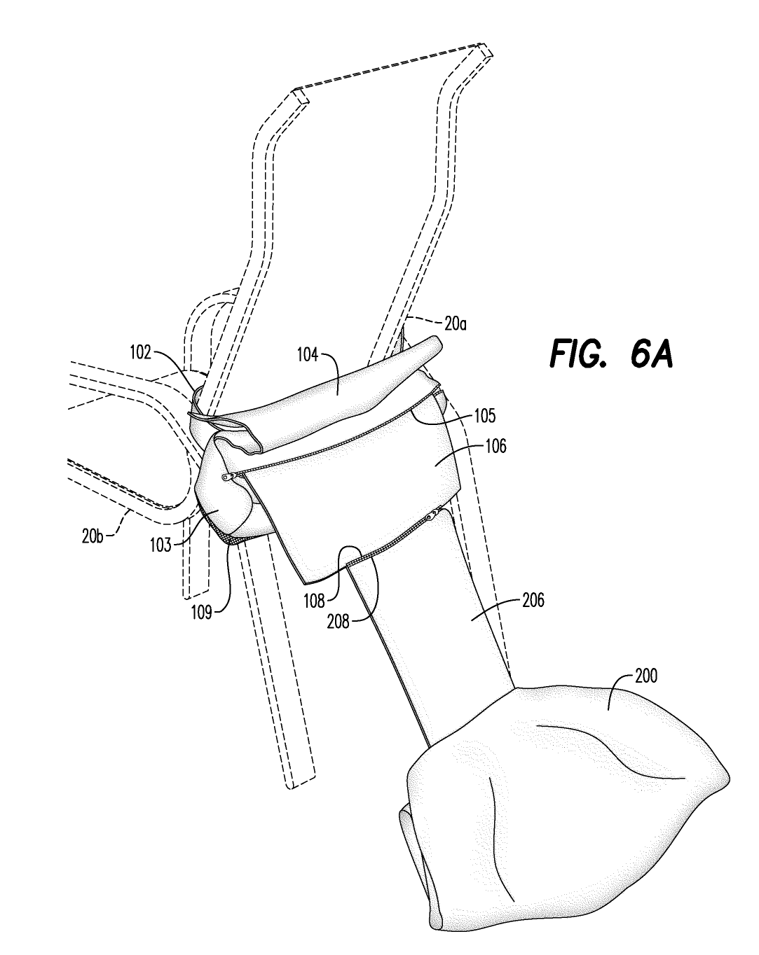

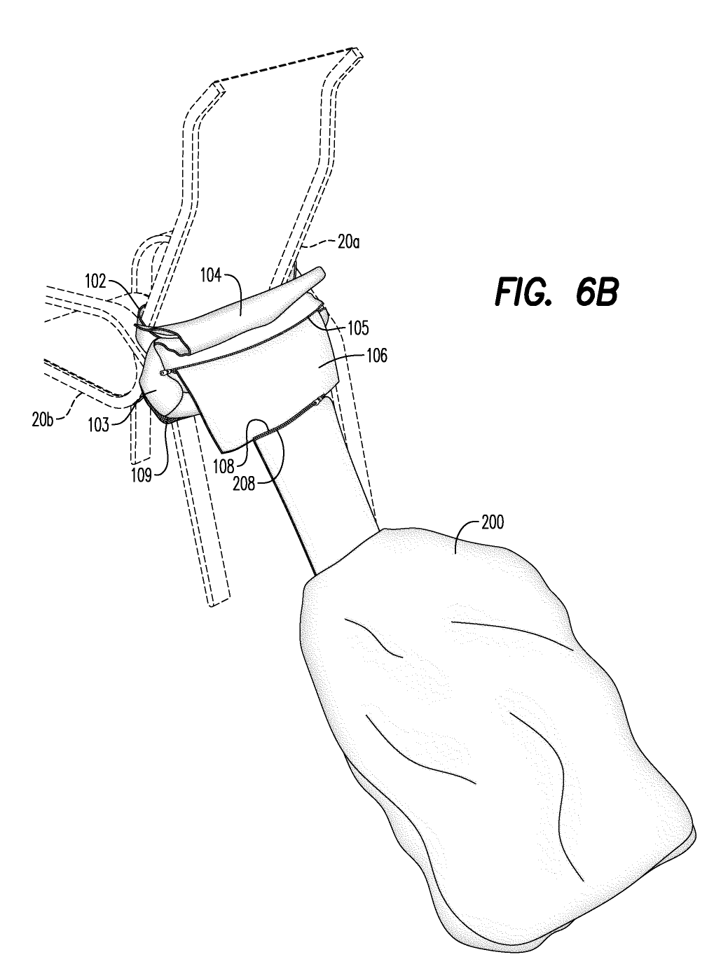

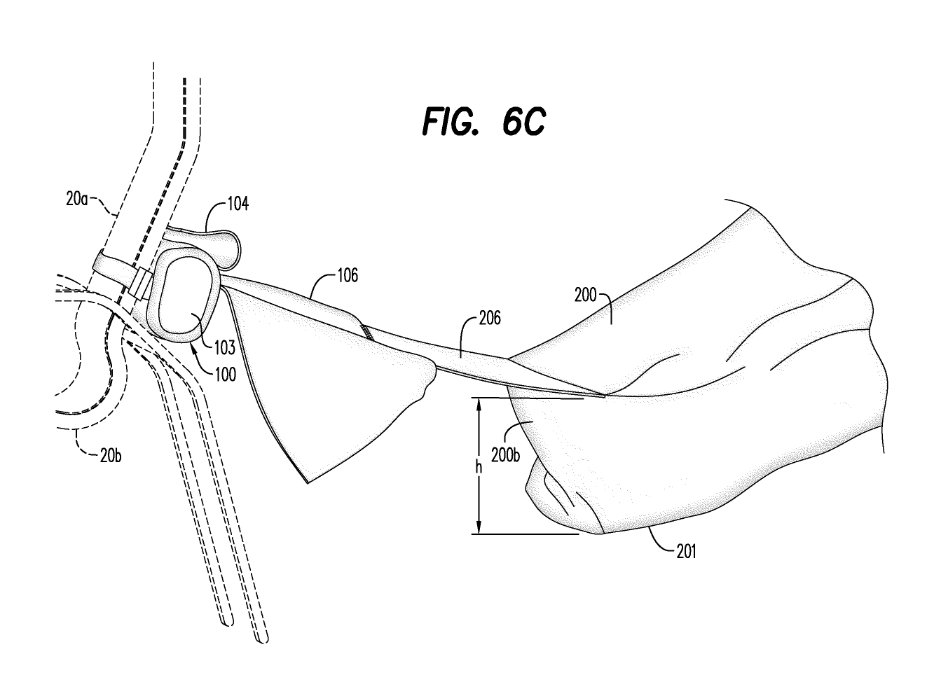

Referring to FIGS. 5, 6A, 6B, and 6C, inside the opening 105 is a cover portion 200 (shown in FIGS. 6A-6C) that may be removed from the compartment 103 by a user. The compartment 103 may rest at a position near a bottom of the back 20a of the chair (or any height desired). In this example, the front of the compartment 103 may face outwards from the back 20a of the chair. When the user opens the opening 105 and pulls out the cover portion 200 the cover portion 200 may unroll or otherwise unfold in a direction that is approximately perpendicular to the back 20a of the chair, although the angle is not limited thereto. In some cases, the cover portion 200 may be pulled upwards and away from the back 20a of the chair, or the like. As a result, it is very easy for the user to unzip the attachment mechanism that secures the opening 105 and pull out the cover portion 200 from the compartment 103.

FIG. 6A illustrates an example of an interior attachment system of the cover assembly 100 between the compartment 103 and the cover portion 200. In this example, the compartment 103 includes an interior (not shown) that is shaped like a pouch or the inside of a duffle bag. The compartment 103 also includes a pouch-extending tongue 106 that is approximately the same width as the compartment 103 and that unrolls or otherwise unfolds from the opening 105 of the compartment 103 causing a distal end of the pouch-extending tongue 106 to protrude from out of the opening 105 of the compartment 103. The pouch-extending tongue 106 may be connected to, sewn in, or otherwise integrated with the interior of the compartment 103. Likewise, the cover portion 200 includes a cover-extending tongue 206 that is capable of attaching to the pouch-extending tongue 106 via attachment mechanisms 108/208 which in this example includes male and female zipper ends. Although, it should be appreciated that the attachment mechanisms may be any desired mechanism such as buttons, ties, knots, zippers, hook and loop, clips, pins, a combination thereof, and the like.

One benefit of such a tongue system is that it allows a user to conveniently and easily attach the cover-extending tongue 206 to the pouch-extending tongue 106 via the combination of attachment mechanisms 108/208. Furthermore, because the pouch-extending tongue 106 is able to be withdrawn completely from the compartment 103 thus exposing attachment mechanism 108 on the distal end thereof, the user can quickly and easily attach the cover portion 200 via the attachment mechanism 208, or substitute a different cover portion that has a same attachment mechanism. As another example, the pouch-extending tongue 106 and the cover-extending tongue 206 may be constructed of one piece without the need to attach/detach the two tongues (i.e., without needing to attach/detach the cover portion 200 to the compartment 103). In this example, the cover portion 200 may be unified with or otherwise integrated with the compartment 103 without attachment mechanisms 108/208.

FIG. 6B illustrates an example of the pouch-extending tongue 106 being attached to the cover-extending tongue 206 while the cover portion 200 is unrolled from the compartment 103. As shown in this example, the cover portion 200 includes a size and shape configured to cover the chair but it should be appreciated that the size and shape of the cover portion 200 may differ. Also, in this example, the compartment 103 attaches to the back of the chair and hangs at a position that is approximate to where the back of the chair and the seat of the chair intersect, however, the embodiments are not limited thereto. As shown in this example, the cover portion 200 is capable of being withdrawn completely from the compartment 103 because of the tongue attachment system. In other words, there is some space between the cover portion 200 and the compartment 103 secured to the chair provided by the tongue attachment system while the compartment 103 also maintains a connection to the cover portion 200. Accordingly, the cover portion 200 can be easily unpacked from the compartment 103 and draped over the chair by a user. Furthermore, when the cover portion 200 is no longer needed to cover the chair, the user can quickly and easily roll up the cover portion 200 and return the cover portion 200 to the compartment 103 while the cover portion 200 remains attached to the compartment 103 at all times.

FIG. 6C illustrates an example of a position at which the cover extending tongue 206 connects to an underneath side of the cover portion 200. Referring to FIG. 6C, an inside-out cover portion 200 is shown depicting a predetermined space (distance h) is provided between a point of connection of the cover-extending tongue 206 and an exterior edge 201 of the cover portion 200. The result is that a predetermined space 200b of the cover portion 200 exists between the point of connection of the cover-extending tongue 206 with the cover portion 200 and the exterior edge 201 of the cover portion 201. Accordingly, when the cover portion 200 is flipped out side out by the user and placed over the chair, the exterior edge 201 is configured to hang below the compartment 103 thereby covering the compartment 103 and the chair while the cover portion 200 remains attached to the compartment 103 via the tongue attachment system include the cover-extending tongue 206 and the pouch-extending tongue 106.

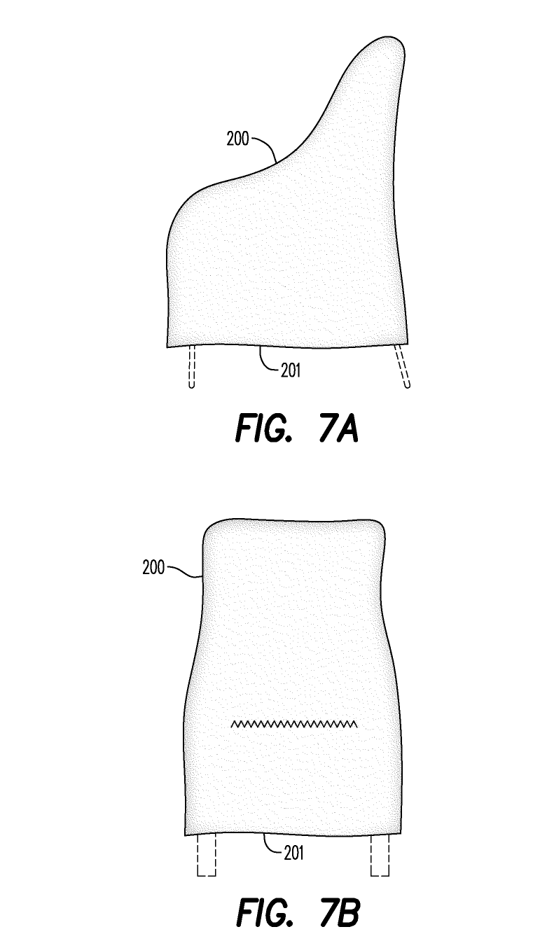

FIGS. 7A and 7B illustrate examples in which the cover portion 200 of the cover assembly 100 is in use and covering an object such as a chair. In this example, the compartment 103 is hidden from view and completely covered from sight by the cover portion 200. Furthermore, the exterior edge 201 of the cover portion 200 surrounds the object and hangs at a point closest to the ground/floor while completely surrounding the object. It should also be appreciated that the exterior edge 201 may contact the ground and is not limited to the length shown in the examples of FIGS. 7A and 7B.

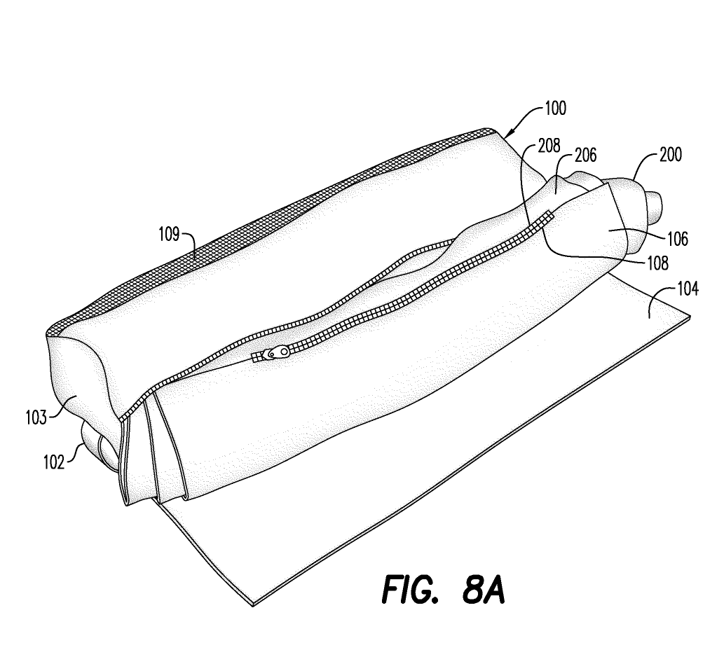

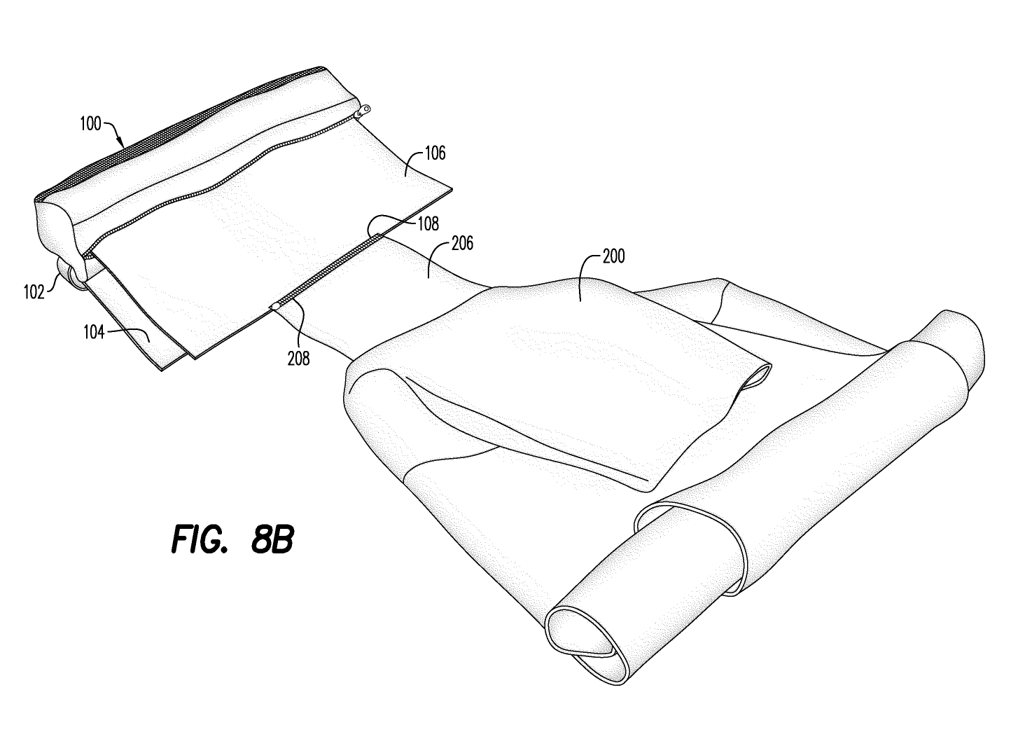

FIGS. 8A and 8B illustrate examples of unrolling or otherwise unfolding the cover portion 200 from the compartment 103 of the cover assembly 100. As shown in these examples, the cover portion 200 and the pouch-extending tongue 106 of the compartment 103 are configured to be rolled-up together and inserted inside the pouch-shaped interior of the compartment 103. In the examples of FIGS. 8A and 8B, when the user begins to unroll the cover portion 200, the pouch-extending tongue 106 is the first piece to be unrolled, then the cover-extending tongue 206, and then the cover portion 200. Furthermore, the combined contents (e.g., cover portion 200 and pouch-extending tongue 106) may be fully unrolled or otherwise unpacked or unfolded while the contents remain connected to the interior of the compartment 103. Accordingly, a user can use the object (which the compartment 103 is attached to) as leverage for unrolling the cover portion 200.

The cover assembly provided herein provides an easy, convenient, and well-protected storage compartment for storing a cover piece as well as easy retrieval, deployment, and return of the cover piece while the compartment is attached to a precise location of need. Furthermore, different combinations of cover pieces may be attached/substituted easily allowing the cover to be modified in mere seconds and used to cover different types of objects. Furthermore, the cover may attach to multiple positions on any one object where it does not interfere or intrude with the function of the respective object. As a result, during storage the cover may remain attached to the object even when not being used without interrupting the use and enjoyment of the object. The multi-positioning ability of the cover assembly enables the cover to be placed at multiple or even many different positions on the object while still providing adequate coverage for the object. Furthermore, the cover portion may be designed with enough size such that the multi-positioning of the cover assembly does not affect the ability of the cover portion to provide adequate protection to the object.

While the examples above describe the cover assembly being used to cover an object such as a piece of furniture, the embodiments are not limited thereto. As another example, the cover assembly may be used to cover a motorcycle or other vehicle or bicycle. In this example, the compartment of the cover assembly may attach to a seat of the motorcycle using a strap, attach to location on the body of the motorcycle using magnets embedded with the cover assembly, or the like. In this example, the compartment and the cover portion of the cover assembly may be shaped and sized different to correspond to the size of a motorcycle or other vehicle.

The above descriptions and illustrations of processes herein should not be considered to imply a fixed order for performing the process steps. Rather, the process steps may be performed in any order that is practicable, including simultaneous performance of at least some steps. Although the present disclosure has been described in connection with specific exemplary embodiments with reference to the drawings, it should be understood that various changes, substitutions, and alterations apparent to those skilled in the art can be made to the disclosed embodiments and drawings without departing from the spirit and scope of the disclosure as set forth in the appended claims.

What is claimed is:

1. A cover assembly comprising:
a compartment that attaches to an object and comprises a pouch-shaped interior and a pouch-extending tongue that includes an interior end that is connected to the pouch-shaped interior and a distal end that is opposite to the interior end, wherein, when stored, the pouch-extending tongue fits inside the pouch-shaped interior, and when opened, the distal end of the pouch-extending tongue extends out of the pouch-shaped interior; and
a cover portion that has a shape and size configured to cover the object, the cover portion comprising a cover-extending tongue that is connected to an underneath side of the cover portion and a distal end that extends outward and attaches to the distal end of the pouch-extending tongue thereby attaching the cover portion to the compartment,
wherein a predetermined space exists on the underneath side of the cover portion between the cover-extending tongue and an exterior edge of the cover portion such that when the cover portion is placed over the object, the exterior edge is configured to hang below the compartment thereby covering the compartment while the cover portion remains attached to the compartment via the cover-extending tongue and the pouch-extending tongue.

2. The cover assembly of claim 1, wherein the cover portion is configured to cover furniture that includes at least one of an outdoor chair, an indoor chair, a sofa, a table, a barbeque grill, and a boat chair.

3. The cover assembly of claim 2, wherein, when the cover portion is placed over a chair, the cover portion is configured to cover a back and a seat of the chair and an entirety of the exterior edge of the cover portion is configured to hang below the compartment and surrounds the chair.

4. The cover assembly of claim 3, wherein the compartment comprises an adjustable strap that is configured to secure the compartment to a back of the chair, and the adjustable strap is detachable from the compartment.

5. The cover assembly of claim 4, wherein, when attached to the back of the chair, the pouch-extending tongue is configured to be unrolled in a direction away from a backside of the back of the chair.

6. The cover assembly of claim 4, wherein the adjustable strap comprises a release mechanism thereby releasing the compartment from the chair, and the release mechanism is configured to be separated by a user and includes at least one of a buckle, a zipper, a button, a rope, a hook and loop, and ties.

7. The cover assembly of claim 1, wherein the distal end of the pouch-extending tongue and the distal end of the cover-extending tongue attach to each other via an attachment mechanism comprising at least one of a zipper, buttons, clips, pins, hook and loop, snaps, and ties.

8. The cover assembly of claim 7, wherein the cover portion is a removable cover portion capable of being removed and replaced with a different size cover portion that has a same connection mechanism.

9. The cover assembly of claim 1, wherein the distal end of the pouch-extending tongue and the distal end of the cover-extending tongue are implemented together as a uniform tongue.

10. The cover assembly of claim 1, wherein the compartment comprises a waterproof duffle bag that is made of waterproof fabric and has a shape of at least one of a cylindrical shape, a rectangular shape, and a spherical shape.

11. The cover assembly of claim 8, wherein a portion of a surface of the waterproof duffle bag comprises mesh ventilation enabling surrounding air to ventilate the compartment and its contents.

12. The cover assembly of claim 1, wherein, when attached to each other, the cover portion and the pouch-extending tongue are configured to be rolled-up together and inserted inside the pouch-shaped interior of the compartment.

13. The cover assembly of claim 1, wherein each of the pouch-extending tongue and the cover portion comprise a waterproof fabric.

14. The cover assembly of claim 1, wherein the compartment comprises a securing mechanism to securely close an opening of the compartment while the pouch-extending tongue and the cover portion are rolled-up together inside, and further comprises a flap that hides the opening.

15. The cover assembly of claim 1, wherein the cover portion is configured to cover equipment comprising at least one of machinery, factory equipment, and garden equipment.

16. The cover assembly of claim 1, wherein the cover portion is configured to cover at least one of leisure vehicles and work vehicles comprising at least one of an automobile, a motorbike, a motorcycle, a bicycle, a lawnmower, a wagon, a tractor, and a non-automated vehicle.

17. A cover comprising:
a compartment that attaches to an object and comprises a pouch-shaped interior; and
a cover portion that has a shape and size configured to cover the object and compartment, the cover portion comprising a tongue that is connected to an underneath side of the cover portion and, at an opposite end thereof, is integrated within the pouch-shaped interior of the compartment thereby connecting the cover portion and the compartment,
wherein, when stored, the cover portion fits inside the pouch-shaped interior of the compartment, and when opened, the cover portion extends outward and away from the pouch-shaped interior and is capable of being placed over the object, and
a predetermined space exists on the underneath side of the cover portion between the tongue and an exterior edge of the cover portion such that when the cover portion covers the object, the exterior edge is configured to hang below the compartment thereby covering the compartment while the cover portion remains attached to the compartment via the tongue.

18. The cover of claim 17, wherein the cover portion is configured to cover furniture including at least one of an outdoor chair, an indoor chair, a sofa, a table, a barbeque grill, and a boat chair.

19. The cover of claim 18, wherein, when the cover portion is covering a chair, the cover portion envelopes a back and a seat of the chair and an entirety of the exterior edge of the cover portion hangs below the compartment and surrounds the chair.

20. The cover of claim 17, wherein the compartment comprises a waterproof duffle bag, the cover portion comprises a waterproof fabric material, and the waterproof duffle bag further comprises mesh ventilation for ventilating the cover portion while it is stored therein.
